(19) United States
(12) Patent Application Publication
(10) Pub. No.: US 2026/0237796 A1
(43) Pub. Date: Aug. 13, 2026

(54) ENERGY STORAGE MODULE

(71) Applicant: TOYOTA JIDOSHA KABUSHIKI KAISHA, Toyota-shi (JP)

(72) Inventor: Satoshi NAKASHIMA, Toyota-shi (JP)

(73) Assignee: TOYOTA JIDOSHA KABUSHIKI KAISHA, Toyota-shi (JP)

(21) Appl. No.: 19/413,472

(22) Filed: Dec. 9, 2025

(30) Foreign Application Priority Data
Feb. 13, 2025 (JP) 2025-021493

(51) Int. Cl. H01M 50/105

(52) U.S. Cl. CPC H01M 50/105

(57) ABSTRACT

An energy storage module includes a power generating element, and an outer casing that covers the power generating element. The outer casing includes: a first outer casing portion that covers a surface and a corner of the power generating element; a folded portion that is continuous with the first outer casing portion, protrudes from a side surface of the power generating element, and is folded back onto the side surface of the power generating element; and a second outer casing portion that is continuous with the folded portion and covers a corner of the first outer casing portion.

### CROSS-REFERENCE TO RELATED APPLICATION

This application claims priority to Japanese Patent Application No. 2025-021493 filed on February 13, 2025. The disclosure of the above-identified application, including the specification, drawings, and claims, is incorporated by reference herein in its entirety.

### BACKGROUND

### 1. Technical Field

The present disclosure relates to energy storage modules.

### 2. Description of Related Art

Japanese Unexamined Patent Application Publication No. 2004-39271 (JP 2004-39271 A) discloses an energy storage module in which spacers are disposed at the inner corners of a recess of an outer casing covering a power generating element, in order to suppress damage to the outer casing.

### SUMMARY

However, when spacers are disposed inside the outer casing as in the energy storage module disclosed in JP 2004-39271 A, the volumetric energy density decreases.

The present disclosure has been made in view of the foregoing, and an object thereof is to provide an energy storage module that can improve the reliability of the energy storage module while suppressing a decrease in volumetric energy density.

An energy storage module according to the present disclosure includes a power generating element, and an outer casing that covers the power generating element. The outer casing includes: a first outer casing portion that covers a surface and a corner of the power generating element; a folded portion that is continuous with the first outer casing portion, protrudes from a side surface of the power generating element, and is folded back onto the side surface of the power generating element; and a second outer casing portion that is continuous with the folded portion and covers a corner of the first outer casing portion.

According to the present disclosure, the strength of the corner is increased by folding back the outer casing. Therefore, it is possible to improve the reliability of the energy storage module while suppressing a decrease in volumetric energy density.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of an energy storage module according to an embodiment;

FIG. 2 is a plan view of the energy storage module according to the embodiment;

FIG. 3 is a sectional view of the energy storage module shown in FIG. 2 taken along line A-A;

FIG. 4 is a side view of a first modification of the energy storage module according to the embodiment;

FIG. 5 is a plan view of the first modification of the energy storage module according to the embodiment; and

FIG. 6 is a sectional view showing a second modification of the energy storage module according to the embodiment.

### DETAILED DESCRIPTION OF EMBODIMENTS

An energy storage module according to an embodiment of the present disclosure will be described with reference to the drawings. The components in the embodiment described below include components that can be readily replaced by those skilled in the art, or components that are substantially equivalent to those described in the embodiment.

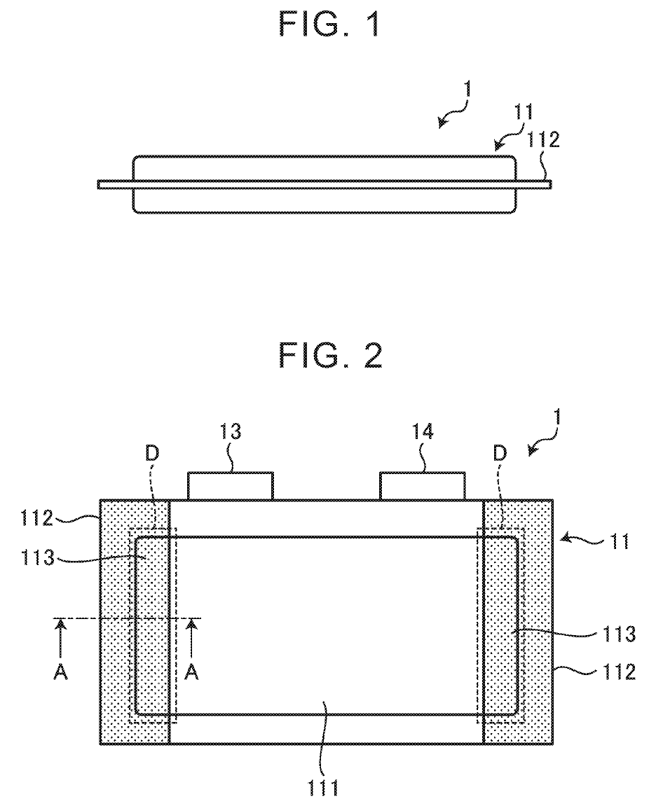

The configuration of the energy storage module according to the embodiment will be described with reference to FIGS. 1 to 3. The energy storage module of the embodiment is used, for example, as a battery for a hybrid electric vehicle, a plug-in hybrid electric vehicle, or a battery electric vehicle.

The energy storage module of the embodiment is specifically a monopolar or bipolar lithium-ion secondary battery. In the following description, the energy storage module of the embodiment is a monopolar lithium-ion secondary battery.

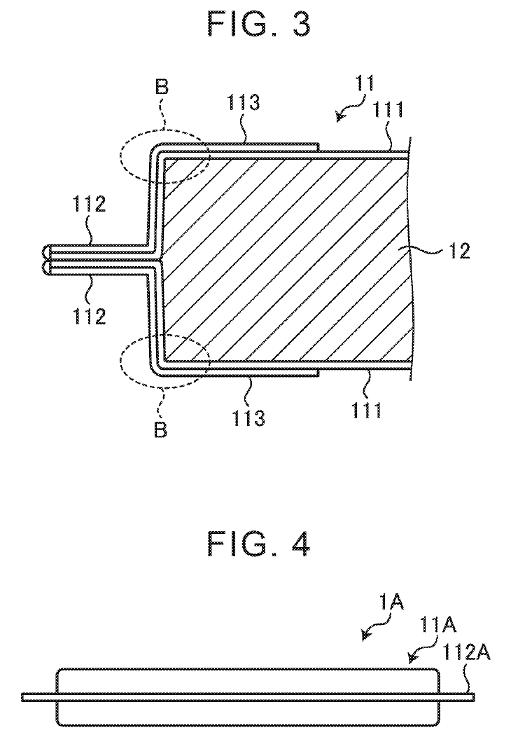

FIG. 1 is a side view of an energy storage module 1 according to the embodiment. FIG. 2 is a plan view of the energy storage module 1. FIG. 3 is a sectional view of the energy storage module 1 shown in FIG. 2 taken along line A-A. The energy storage module 1 includes an outer casing 11, a power generating element 12, a cathode tab lead 13, and an anode tab lead 14.

The outer casing 11 serves to cover the power generating element 12. The outer casing 11 houses the power generating element 12 together with, for example, an electrolyte solution. As shown in FIG. 2, the outer casing 11 is constituted by two laminate films that cover the upper side and the lower side of the power generating element 12.

The laminate film constituting the outer casing 11 has a structure in which multiple materials are laminated. For example, the laminate film includes a first resin layer made of nylon resin (polyamide resin), an adhesive layer, a metal layer made of aluminum foil, and a second resin layer made of polyethylene (PE) or polypropylene (PP). The first resin layer and the second resin layer are formed of such a thermoplastic resin (heat-sealable resin) as described above.

As shown in FIG. 3 in detail, the outer casing 11 is constituted by a first outer casing portion 111, a folded portion 112, and a second outer casing portion 113.

The first outer casing portion 111 covers the surfaces (top and bottom surfaces) of the power generating element 12. As shown in parts B of FIG. 3, the first outer casing portion 111 covers the corners of the power generating element 12.

The folded portion 112 is continuous with the first outer casing portion 111. The folded portion 112 protrudes outward from the side surface of the power generating element 12 and is folded back onto the side surface of the power generating element 12. As shown in FIG. 2, the folded portions 112 are provided on two out of the four sides of the rectangular outer casing 11, namely the right and left sides on the drawing sheet.

The second outer casing portion 113 is continuous with the folded portion 112. As shown in parts B of FIG. 3, the second outer casing portion 113 is located outward of the first outer casing portion 111 and covers the corners of the first outer casing portion 111.

In this way, in the energy storage module 1, both ends of the laminate films that constitute the outer casing 11 are folded back, and both the ends of the folded back laminate films are located on the top and bottom surfaces of the power generating element 12. In the energy storage module 1, the corners of the power generating element 12 are doubly covered by the first outer casing portion 111 and the second outer casing portion 113.

In the energy storage module 1, the first outer casing portion 111 and the second outer casing portion 113 are welded together. In the energy storage module 1, the folded portion 112 continuous with the upper first outer casing portion 111 and the folded portion 112 continuous with the lower first outer casing portion 111 are welded together.

The outer casing 11 is manufactured, for example, by the following procedure.
(1) The laminate films are bent as shown in FIG. 3.
(2) Using a heat bar, an impulse sealer, or the like, the first outer casing portion 111 and the second outer casing portion 113 are welded together, and the upper and lower folded portions 112 are also welded together.
(3) Embossing (projection molding) is performed using a press mold.

The power generating element 12 is composed of a laminated electrode in which a plurality of cathode sheets and a plurality of anode sheets are laminated with separators interposed therebetween. Each cathode sheet constituting the power generating element 12 is connected to the cathode tab lead 13. Each anode sheet constituting the power generating element 12 is connected to the anode tab lead 14.

The cathode tab lead 13 is connected to each cathode sheet constituting the power generating element 12 and extends to the outside of the outer casing 11. The anode tab lead 14 is connected to each anode sheet constituting the power generating element 12 and extends to the outside of the outer casing 11.

In the energy storage module 1 having the above configuration, the strength of the corners is increased by folding back the outer casing 11. Therefore, it is possible to improve the reliability of the energy storage module 1 while suppressing a decrease in volumetric energy density. That is, the energy storage module 1 has a structure in which a multilayer structure portion formed by folding back and welding the laminate films constituting the outer casing 11 is located at the corner of the embossed laminate films. This increases the strength of the corners, and improves the reliability of the energy storage module 1 even without the need for spacers as in the related art.

In the energy storage module 1, the strength of the outer casing 11 can be increased by welding the first outer casing portion 111 that is the first layer and the second outer casing portion 113 that is the second layer. In particular, it is possible to take measures against cracks and the like by reinforcing the portions (corners) where stress is concentrated due to cold and heat.

Even if the laminate films constituting the outer casing 11 are not doubled as in the energy storage module 1, damage to the corners can be suppressed by increasing the thicknesses of the metal layers (aluminum foils) of the laminate films. When attempting to produce a laminate film with a thickness greater than a certain level, however, productivity drops significantly. In the energy storage module 1, the laminate films are folded back to form a multilayer structure in order to increase the rigidity of the laminate films without reducing productivity.

### First Modification

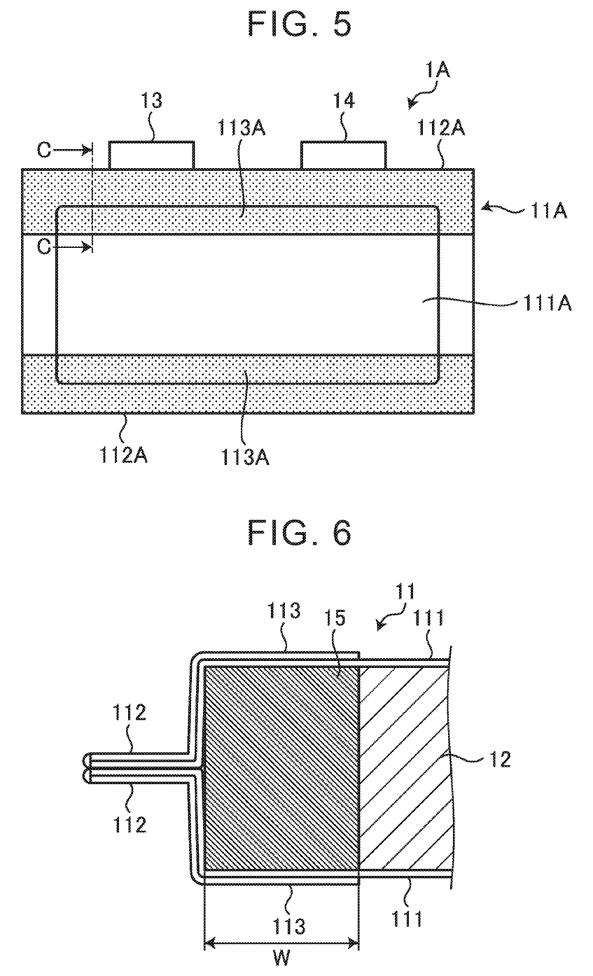

A first modification of the energy storage module according to the embodiment will be described with reference to FIGS. 4 and 5. In the energy storage module 1, the folded portions 112 are provided on two out of the four sides of the outer casing 11, namely the right and left sides on the drawing sheet (see FIG. 2), but the positions where the folded portions 112 are provided are not limited to these.

An outer casing 11A of an energy storage module 1A shown in FIGS. 4 and 5 is constituted by a first outer casing portion 111A, a folded portion 112A, and a second outer casing portion 113A. In the energy storage module 1A shown in FIG. 5, the state of the energy storage module 1A taken along line C-C is the same as that shown in FIG. 3.

The first outer casing portion 111A covers the surfaces (top and bottom surfaces) and the corners of the power generating element 12. The folded portion 112A is continuous with the first outer casing portion 111A.

The folded portion 112A protrudes outward from the side surface of the power generating element 12 and is folded back onto the side surface of the power generating element 12. As shown in FIG. 5, the folded portions 112A are provided on two out of the four sides of the rectangular outer casing 11A, namely the top and bottom sides on the drawing sheet.

The second outer casing portion 113A is continuous with the folded portion 112A. The second outer casing portion 113A is located outward of the first outer casing portion 111A and covers the corners of the first outer casing portion 111A.

In the energy storage module 1A having the above configuration, the strength of the corners is increased by folding back the outer casing 11A. Therefore, it is possible to improve the reliability of the energy storage module 1A while suppressing a decrease in volumetric energy density. That is, the energy storage module 1A has a structure in which a multilayer structure portion formed by folding back and welding the laminate films constituting the outer casing 11A is located at the corner of the embossed laminate films. This increases the strength of the corners, and improves the reliability of the energy storage module 1A even without the need for spacers as in the related art.

### Second Modification

A second modification of the energy storage module according to the embodiment will be described with reference to FIG. 6. In the energy storage module 1, as shown in FIG. 6, for example, a spacer 15 may be provided inside the outer casing 11 as needed.

The spacer 15 is made of, for example, synthetic resin, and is provided at the end of the inside of the outer casing 11. The spacer 15 has a rectangular cross section as shown in FIG. 6 and has a rod shape as a whole. The spacer 15 is provided, for example, at a position indicated by "D" in FIG. 2.

The spacer 15 is not intended to protect the corners but to suppress pressure recovery when pressure is reduced. Since the spacer 15 is not intended to protect the corners, the spacer 15 need not be provided at both ends of the inside of the outer casing 11 (two parts D in FIG. 2). It is sufficient to provide the spacer 15 at least at one of the ends (one of the two parts D in FIG. 2).

When the spacer 15 is provided at the end of the inside of the outer casing 11, it is also possible that the second outer casing portion 113 is not located on the upper side and the lower side of the power generating element 12 as shown in FIG. 6. A width W of the spacer 15 is set to a size according to the amount of generation of pressure recovery gas and to the minimum size at which the volumetric energy density does not decrease. Although the example in which the spacer 15 is provided in the energy storage module 1 has been described with reference to FIG. 6, the spacer 15 may be provided in the energy storage module 1A.

According to the second modification of the energy storage module having the above configuration, the folded structure of the outer casing 11 can increase the strength of the corners, and the provision of the spacer 15 can suppress the pressure recovery when pressure is reduced.

Further effects and modifications can be readily derived by those skilled in the art. Therefore, the broader aspects of the present disclosure are not limited to the specific details and exemplary embodiments shown and described above. Accordingly, various modifications may be made without departing from the spirit or scope of the general inventive concept defined by the appended claims and their equivalents.

For example, in FIGS. 1 to 6, the description has been given on the assumption that the energy storage module according to the embodiment is a monopolar lithium-ion secondary battery, but a similar structure can be applied even when the energy storage module according to the embodiment is a bipolar lithium-ion secondary battery.

What is claimed is:

1. An energy storage module comprising:
a power generating element; and
an outer casing that covers the power generating element, wherein
the outer casing includes:
a first outer casing portion that covers a surface and a corner of the power generating element;
a folded portion that is continuous with the first outer casing portion, protrudes from a side surface of the power generating element, and is folded back onto the side surface of the power generating element; and
a second outer casing portion that is continuous with the folded portion and covers a corner of the first outer casing portion.
